(19) United States
(12) Patent Application Publication
(10) Pub. No.: US 2003/0218790 A1
(43) Pub. Date: Nov. 27, 2003

(54) Chirp control in a high speed optical transmission system

(75) Inventors: Benny P. Mikkelsen, Boston, MA (US); Christian J. Rasmussen, Nashua, NH (US); Tina Fjelde, Boston, MA (US); Fenghai Liu, Nashua, NH (US); Pavel V. Mamyshev, Morganville, NJ (US); David Wolfson, Boston, MA (US); John E. Kaufmann, Maynard, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: MINTERA CORPORATION

(21) Appl. No.: 10/391,534

(22) Filed: Mar. 17, 2003

Related U.S. Application Data
(60) Provisional application No. 60/380,452, filed on May 14, 2002.

(51) Int. Cl. G02F 1/01; G02B 26/00

(52) U.S. Cl. 359/238

(57) ABSTRACT

A high speed digital optical transmission system that improves data transmission performance in both linear and nonlinear system environments. The high speed optical transmission system includes a laser for generating a CW light beam, and a data modulator for modulating the CW light beam in response to an electrical NRZ data signal to generate a modulated NRZ optical signal with positive chirp. The bias point of the data modulator is obtained by increasing the bias offset relative to quadrature while maintaining the voltage corresponding to a 0 bit at a predetermined level. The bias point allows the data modulator to be operated so that the chirp of the modulated NRZ optical signal is positive for most of each bit time slot.

### CROSS REFERENCE TO RELATED APPLICATIONS

This application claims priority of U.S. Provisional Patent Application No. 60/380,452 filed May 14, 2002 entitled OPTICAL TRANSMISSION SYSTEM METHODS AND APPARATUS.

### STATEMENT REGARDING FEDERALLY SPONSORED RESEARCH OR DEVELOPMENT

N/A

### BACKGROUND OF THE INVENTION

The present invention relates generally to digital optical transmission systems, and more specifically to high speed digital optical transmission systems employing enhanced chirp control techniques to improve data transmission performance.

Digital optical transmission systems are known that employ chirp control techniques to improve data transmission performance. A conventional digital optical transmission system includes a laser for generating a Continuous Wave (CW) light beam, and a data modulator for modulating the CW light beam in response to an electrical data signal to generate a modulated optical signal carrying the data. Because the electrical data signal typically has a Non-Return-to-Zero (NRZ) data format, the optical signal generated by the data modulator typically has an NRZ modulation format. It is also known to employ a Return-to-Zero (RZ) modulation format in digital optical transmission systems. Like the NRZ data transmission system, the conventional optical transmission system employing the RZ modulation format includes a laser for generating a CW light beam, and a data modulator for modulating the CW light beam in response to an electrical NRZ data signal. In addition, the conventional RZ data transmission system includes an RZ pulse modulator for carving RZ pulses from the modulated optical signal carrying the NRZ data.

Conventional NRZ or RZ optical transmission systems operating at bit rates of about 10 Gbits/s typically deploy either negative chirp (i.e., decreased optical frequency at leading edges of the modulated optical signal and increased optical frequency at trailing edges of the modulated signal) or no chirp (i.e., essentially no change in the optical frequency of the modulated optical signal) at the optical transmitter when transmitting data over optical fiber having positive dispersion characteristics. This is to achieve what is commonly known as the “maximum dispersion distance”, which is the fiber distance beyond which neighboring data bits start to overlap and interfere. For example, the maximum dispersion distance for the conventional 10 Gbits/s optical transmitter is approximately 60 km of Standard Single-Mode Fiber (SSMF). Another fiber distance that impacts optical transmission performance is the “effective non-linear fiber distance”, which is the fiber distance over which the optical signal power is high enough to introduce impairment from fiber non-linearity. For example, the effective non-linear fiber distance for the conventional 10 Gbits/s optical transmitter is approximately 20 km of SSMF. In general, for optical transmitters operating at bit rates up to about 10 Gbits/s, the maximum dispersion distance is longer than the effective non-linear fiber distance. Because of the interplay between dispersion and fiber non-linearity in the transmission of optical data, conventional NRZ or RZ optical transmission systems operating at bit rates of about 10 Gbits/s typically employ both chirp control (e.g., negative chirp or no chirp) and dispersion mapping (e.g., placing dispersion compensating fiber at certain positions in the transmission link) techniques to optimize the overall data transmission performance.

Although the maximum dispersion distance is generally longer than the effective non-linear fiber distance at bit rates up to about 10 Gbits/s, this is generally not the case for digital optical transmission systems operating at bit rates above 10 Gbits/s. For example, for NRZ and RZ optical transmission systems operating at bit rates of about 40 Gbits/s, the maximum dispersion distance is about 15-16 times shorter than the dispersion distance for 10 Gbits/s systems, e.g., the maximum dispersion distance at 40 Gbits/s is approximately 4 km of SSMF. The effective non-linear fiber distance, however, is approximately the same for 10 Gbits/s and 40 Gbits/s systems, i.e., about 20 km of SSMF. In general, for optical transmitters operating at bit rates of about 40 Gbits/s or higher, the maximum dispersion distance is shorter than the effective non-linear fiber distance. As explained above, the maximum dispersion distance is typically longer than the effective non-linear fiber distance for 10 Gbits/s systems. Because the interplay between dispersion and fiber non-linearity for 10 Gbits/s optical transmission systems is different from systems operating at higher bit rates, e.g., about 40 Gbits/s or higher, the chirp control and dispersion mapping techniques employed in 10 Gbits/s systems generally do not lead to optimal data transmission performance when employed in the higher bit rate systems.

It would therefore be desirable to have an improved digital optical transmission system that can be employed to transmit modulated optical signals at high bit rates, e.g., about 40 Gbits/s or higher. Such a high speed optical transmission system would be capable of providing improved data transmission performance in both linear and nonlinear system environments.

### BRIEF SUMMARY OF THE INVENTION

In accordance with the present invention, a high speed digital optical transmission system is provided that improves data transmission performance in both linear and nonlinear system environments. The presently disclosed high speed optical transmission system achieves such improved data transmission performance by exploiting the interplay of the chirp associated with modulated optical signals, the dispersion characteristics of transmission fiber, and the bias point of a data modulator included in the system.

In a first embodiment, the high speed optical transmission system includes a laser configured to generate a Continuous Wave (CW) light beam, and a data modulator configured to modulate the CW light beam in response to a Non-Return-to-Zero (NRZ) electrical data signal to generate a modulated NRZ optical signal with positive chirp (i.e., increased optical frequency at leading edges of the modulated optical signal and decreased optical frequency at trailing edges of the modulated signal). The chirp of the modulated optical signal is a function of time and may be expressed as

α(t)=4πδf(t)/[P(t)⁻¹(dP(t)/dt)],

in which “δf(t)” is the difference between the instantaneous optical frequency of the modulated light and the optical frequency of the CW light beam at the input of the data modulator, and “P(t)” is the optical power at the output of the modulator. Accordingly, in this first embodiment, the data modulator generates the modulated NRZ optical signal with positive chirp, i.e., α>0.

In a second embodiment, the high speed optical transmission system includes a laser configured to generate a CW light beam, and a data modulator configured to modulate the CW light beam in response to an electrical NRZ data signal to generate a modulated NRZ optical signal that carries the data. The data modulator has an associated transfer function. Further, a bias point for operating the data modulator is offset from a quadrature point of the transfer function. The transfer function of the data modulator may be expressed in terms of the transmitted power versus the drive voltage of the data modulator. In this second embodiment, the bias point is obtained by increasing the bias offset relative to the quadrature point while maintaining the voltage corresponding to a 0 bit at a predetermined logical low level.

In a third embodiment, the high speed optical transmission system includes an optical transmitter, an optical receiver, and a fiber connection connecting the optical transmitter to the optical receiver. The optical transmitter includes a laser configured to generate a CW light beam, and a data modulator configured to modulate the CW light beam in response to an electrical NRZ data signal to generate a modulated NRZ optical signal with positive chirp, i.e., α>0. In this third embodiment, the fiber connection between the optical transmitter and the optical receiver comprises negative or positive dispersion optical fiber.

In a fourth embodiment, the high speed digital optical transmission system includes a laser configured to generate a CW light beam, a data modulator configured to modulate the CW light beam in response to an electrical NRZ data signal to generate a modulated NRZ optical signal with positive chirp, i.e., α>0, and a Return-to-Zero (RZ) pulse modulator configured to carve RZ pulses from the modulated optical signal carrying the NRZ data. The bias point of the data modulator is obtained by increasing the bias offset relative to quadrature while maintaining the voltage corresponding to a 0 bit at a predetermined logical low level. In this fourth embodiment, the bias point allows the data modulator to be operated so that the chirp of the modulated NRZ optical signal is positive most of the time, e.g., for at least 80% of each bit time slot. The RZ pulse modulator may alternatively be configured to produce RZ pulses in the Carrier-Suppressed RZ (CS-RZ) data format, in which each pair of neighboring optical pulses has a relative phase difference of about π radians.

In a fifth embodiment, the high speed optical transmission system includes an optical transmitter, an optical receiver, and a fiber connection connecting the optical transmitter to the optical receiver. The optical transmitter includes a laser configured to generate a CW light beam, a data modulator configured to modulate the CW light beam in response to an electrical NRZ data signal to generate a modulated NRZ optical signal with positive chirp, i.e., α>0, and an RZ pulse modulator configured to carve RZ pulses from the modulated optical signal carrying the NRZ data. In this fifth embodiment, the fiber connection between the optical transmitter and the optical receiver comprises positive dispersion optical fiber.

By exploiting the interplay of the positive chirp of a modulated optical signal, the non-zero dispersion characteristics of transmission fiber, and the bias point of an NRZ data modulator offset from quadrature, enhanced data transmission performance can be achieved in high speed optical transmission systems operating in linear and nonlinear system environments. More specifically, the presently disclosed optical transmission system achieves such enhanced performance by making use of the predominant positive chirp of the NRZ modulated optical signal (i.e., the signal with the RZ carver turned off in the case of an RZ transmitter) in systems using NRZ and CS-RZ modulation format, including all suitable fiber types, all suitable modulator types (including NRZ data modulators in which the amplitude and phase modulation functions are implemented separately), and all suitable bit rates.

Other features, functions, and aspects of the invention will be evident from the Detailed Description of the Invention that follows.

### BRIEF DESCRIPTION OF THE SEVERAL VIEWS OF THE DRAWING

The invention will be more fully understood with reference to the following Detailed Description of the Invention in conjunction with the drawings of which:

FIG. 1 is a block diagram of a conventional digital optical transmission system;

FIGS. 2a-2c are diagrams illustrating power waveforms associated with the conventional digital optical transmission system of FIG. 1;

FIG. 3 is a diagram illustrating a transfer function associated with a data modulator included in the conventional digital optical transmission system of FIG. 1;

FIG. 4 is a block diagram of a high speed digital optical transmission system according to the present invention;

FIG. 5 is a block diagram of an alternative embodiment of the high speed digital optical transmission system of FIG. 4;

FIG. 6 is a diagram illustrating a transfer function associated with a data modulator included in the high speed digital optical transmission system of FIG. 4 or FIG. 5;

FIGS. 7a-7c and 8a-8c are diagrams illustrating transmission penalties corresponding to the high speed digital optical transmission system of FIG. 4;

FIGS. 9a-9i are diagrams illustrating transmission penalties corresponding to the high speed digital optical transmission system of FIG. 5;

FIGS. 10a-10b are diagrams illustrating transfer functions associated with a data modulator included in the high speed digital optical transmission system of FIG. 4 or FIG. 5;

FIG. 11 is a flow diagram illustrating a method of determining a bias point for operating the data modulator included in the high speed digital optical transmission system of FIG. 4 or FIG. 5;

FIG. 12 is a block diagram of a high speed digital optical transmission system including a single drive Mach-Zehnder data modulator;

FIG. 13 is a block diagram of a bias offset control loop employed in conjunction with the Mach-Zehnder modulator of FIG. 12; and

FIG. 14 is a flow diagram illustrating a method of performing closed-loop control of the bias offset of the Mach-Zehnder modulator of FIG. 12.

### DETAILED DESCRIPTION OF THE INVENTION

U.S. Provisional Patent Application No. 60/380,452 filed May 14, 2002 entitled OPTICAL TRANSMISSION SYSTEM METHODS AND APPARATUS is incorporated herein by reference.

A high speed digital optical transmission system is disclosed that provides enhanced data transmission performance in both linear and nonlinear system environments. The presently disclosed high speed optical transmission system employs positive chirp, non-zero dispersion transmission fiber, and a data modulator that is biased to achieve such enhanced performance.

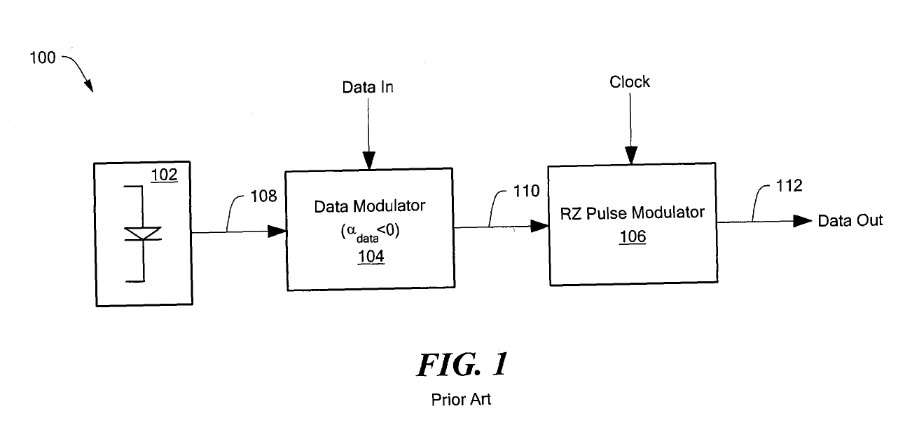

FIG. 1 depicts a conventional digital optical transmission system 100. The conventional optical transmission system 100 includes a laser 102 configured to generate a Continuous Wave (CW) light beam, and an external data modulator 104 configured to modulate the CW light beam in response to an electrical data signal (“Data In”) to generate a modulated optical signal. The Data In signal typically has a Non-Return-to-Zero (NRZ) data format. Accordingly, the modulated optical signal generated by the external data modulator 104 has an NRZ modulation format.

As shown in FIG. 1, the conventional optical transmission system 100 may also include a Return-to-Zero (RZ) pulse modulator 106 driven with an electrical clock signal (“Clock”). The RZ pulse modulator 106 is configured to carve one RZ pulse per bit time slot of the data signal generated by the data modulator 104 to produce an optical data signal (“Data Out”) in the RZ data format. It is noted that the RZ data format is frequently employed by conventional optical transmission systems operating at high bit rates such as about 10 Gbits/s. It is further noted that the laser 102 may alternatively provide the CW light beam directly to the RZ pulse modulator 106, which may then generate one optical RZ pulse for each bit time slot of the data signal and provide this series of RZ pulses to the data modulator 104 for subsequent data modulation. The duration of a bit time slot is equal to one divided by the bit rate. Accordingly, the order of the data modulator 104 and the RZ pulse modulator 106 is not critical in the conventional optical transmission system 100.

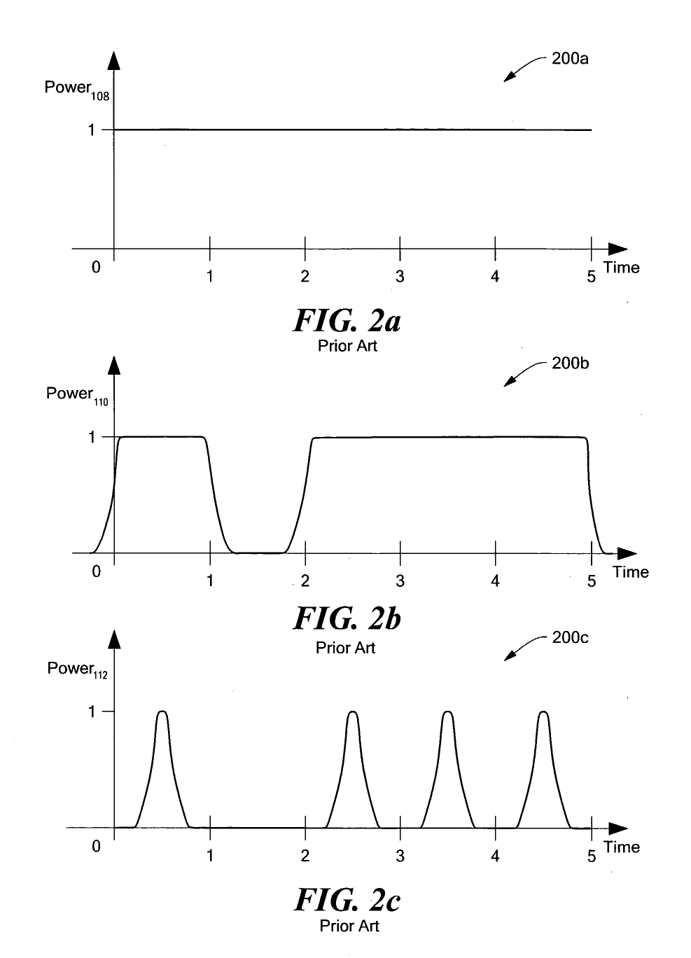

FIGS. 2a-2c depict representations of optical waveforms 200a-200c at respective outputs of the laser 102, the data modulator 104, and the RZ pulse modulator 106. Specifically, FIG. 2a depicts a representation 200a of the optical power of the CW light beam provided by the laser 102 to the data modulator 104 over a transmission fiber 108. As shown in FIG. 2a, the optical power 200a of the CW light beam on the fiber 108 is essentially constant over time. FIG. 2b depicts the optical power 200b provided by the data modulator 104 over an optical fiber 110 after impressing NRZ data modulation on the optical waveform 200a of FIG. 2a. As illustrated by the optical waveform 200b of FIG. 2b, the data provided by the data modulator 104 over five consecutive bit time slots consists of the bits 1, 0, 1, 1, and 1 in NRZ data format. FIG. 2c depicts the optical power 200c provided by the RZ pulse modulator 106 over a transmission fiber 112 after impressing RZ pulse modulation on the optical waveform 200b of FIG. 2b. As illustrated by the optical waveform 200c of FIG. 2c, the Data Out signal produced by the RZ pulse modulator 106 consists of the bits 1, 0, 1, 1, and 1 in RZ data format.

It should be appreciated by those of ordinary skill in this art that the data modulator 104 and the RZ pulse modulator 106 of the conventional digital optical transmission system 100 (see FIG. 1) may be operated to control the chirp of the optical signals generated by the respective modulators. The chirp of a modulated optical signal is a function of time and may be expressed as

α(t)=4πδf(t)/[P(t)⁻¹(dP(t)/dt)], (1)

in which “δf(t)” is the difference between the instantaneous optical frequency of the modulated optical signal generated by the modulator and the optical frequency of a CW light beam at the input of the modulator, and “P(t)” is the optical power at the output of the modulator. It is further appreciated that the chirp of the modulated optical signals may be controlled by choosing a suitable type of modulator, and suitably configuring and biasing the respective modulators. It is noted that the chirp impressed on optical signals by the data modulator 104 and the RZ pulse modulator 106 is indicated herein by the parameters “α_{data}” and “α_{RZ}”, respectively.

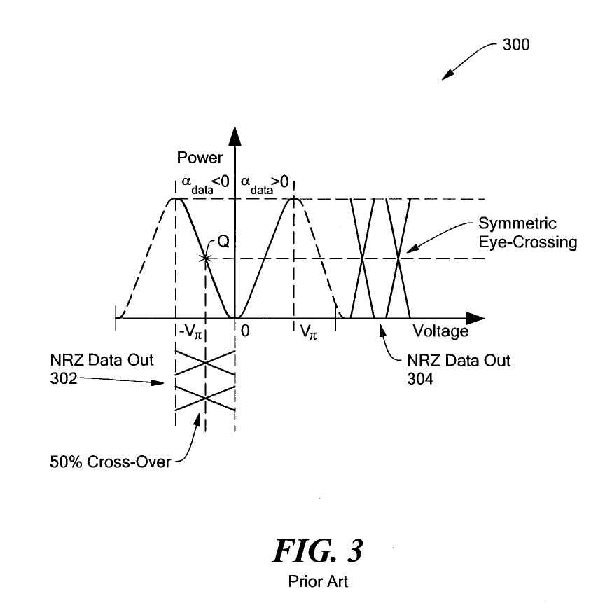

For example, FIG. 3 depicts a typical transfer function 300 of the data modulator 104 (see FIG. 1) configured as a single drive Mach-Zehnder modulator. As shown in FIG. 3, the transfer function 300 is periodic, and is expressed in terms of the optical power of the modulated signal generated by the data modulator 104 versus the drive voltage applied to the modulator 104. It is noted that “V_{π}” represents the drive voltage that changes the phase of the optical field in the modulated arm of the Mach-Zehnder modulator by π radians. As shown in FIG. 3, the alpha parameter is negative (α_{data}<0) in that region of the transfer function 300 where the drive voltage ranges from −V_{π} to 0, and the alpha parameter is positive (α_{data}>0) in that region of the transfer function 300 where the drive voltage ranges from 0 to V_{π}. It is appreciated that depending on how the Mach-Zehnder modulator is configured and biased, the respective regions of the transfer function 300 corresponding to negative chirp and positive chirp may be opposite what is depicted in FIG. 3.

It is known in this art to operate the data modulator 104 to generate modulated optical signals with negative chirp (α_{data}<0), resulting in decreased optical frequency at leading edges of the modulated optical signal and increased optical frequency at trailing edges of the modulated signal. This is particularly useful when employing positive dispersion optical fiber in the fiber connection between the optical transmitter and an optical receiver. For example, the data modulator 104 may be configured to generate modulated optical signals such that α_{data}<0 by biasing the modulator at a quadrature (“Q”) point in that region of the transfer function 300 where the drive voltage ranges from −V_{π} to 0 (see FIG. 3). Accordingly, a representation of an electrical NRZ drive signal (Data In) 302 applied to the data modulator 104 has a 50% cross-over characteristic, and a representation of an optical NRZ output signal (Data Out) 304 generated by the data modulator 104 has a corresponding symmetric eye-crossing characteristic, as shown in FIG. 3.

By operating the data modulator 104 such that α_{data}<0, temporal pulse broadening caused by positive dispersion in the transmission fiber can be reduced. Such temporal broadening of optical pulses can limit the bandwidth of the overall system. It is noted that while operating the data modulator 104 such that α_{data}<0, the RZ pulse modulator 106 may be operated such that α_{RZ}<0, α_{RZ}=0, or α_{RZ}>0. However, the conventional digital optical transmission system 100 employing negative chirp (α_{data}<0) and positive dispersion transmission fiber typically reduces bandwidth limitations only in linear system environments. Such reductions in bandwidth limitations are generally unattainable by the conventional optical transmission system in the presence of fiber non-linearity. In addition, fiber non-linearity causes a type of signal distortion that cannot be viewed as bandwidth limitation, and reduction of this type of signal distortion requires α_{data}>0, as explained below.

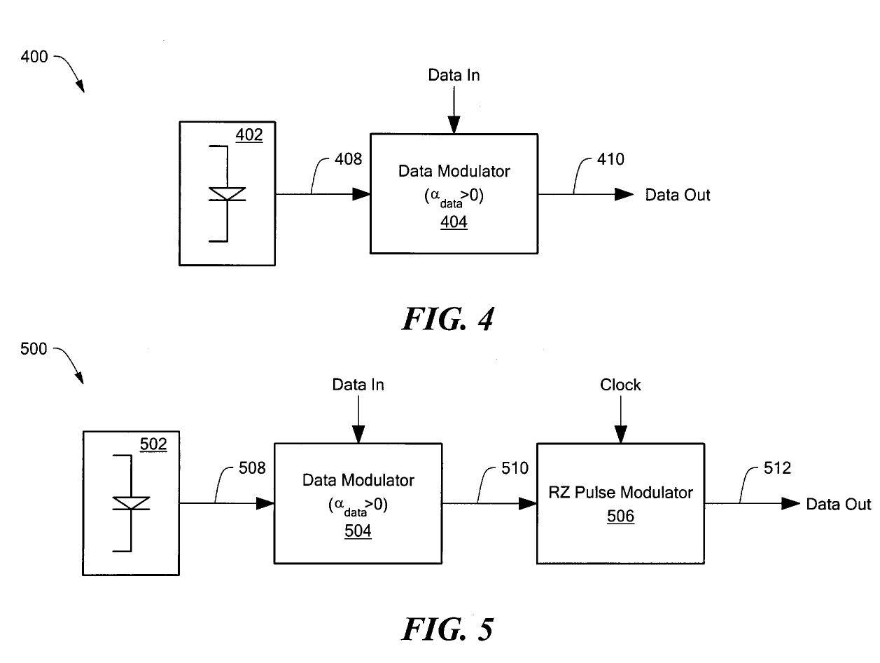

FIGS. 4-5 depict illustrative embodiments of high speed digital optical transmission systems 400 and 500, respectively, in accordance with the present invention. The digital optical transmission systems 400 and 500 can be employed to improve data transmission performance at high bit rates, e.g., 10 Gbits/s or higher, in both linear and nonlinear system environments. It is understood that in nonlinear system environments, the refractive index of optical fiber changes as the power of optical signals carried by the fiber changes, potentially causing a significant increase in the Bit Error Rate (BER) of conventional high speed optical transmission systems.

As illustrated in FIG. 4, the high speed optical transmission system 400 includes a laser 402 configured to generate a CW light beam, and at least one external data modulator 404 configured to modulate the CW light beam in response to an electrical data signal (“Data In”) to generate a modulated optical data signal (“Data Out”). Because the Data In signal typically has an NRZ data format, the Data Out signal generated by the data modulator 404 has an NRZ modulation format. Similarly, as illustrated in FIG. 5, the high speed optical transmission system 500 includes a laser 502 for generating a CW light beam, and at least one external data modulator 504 for modulating the CW light beam in response to an electrical data signal (“Data In”). The optical transmission system 500 further includes an RZ pulse modulator 506 for carving one RZ pulse per bit time slot from the modulated optical signal generated by the data modulator 504 to produce an optical signal (“Data Out”) in the standard RZ data format. It should be understood that the order of the data modulator 504 and the RZ pulse modulator 506 is not critical to the performance of the optical transmission system 500.

It was described above with reference to the conventional optical transmission system 100 (see FIG. 1) that the data modulator 104 typically generates optical signals with negative chirp, i.e., α_{data}<0, to alleviate bandwidth limitations caused by positive dispersion in the transmission fiber. In contrast, the data modulators 404 and 504 included in the high speed optical transmission systems 400 and 500, respectively, are operated to generate modulated optical signals with positive chirp, i.e., α_{data}>0 most of the time. It is understood that positive chirp results in increased optical frequency at leading edges of the modulated optical signal, and decreased optical frequency at trailing edges of the modulated signal. By employing the data modulators 404 and 504 to generate modulated optical signals with positive chirp, reduced signal distortion after transmission can be achieved even in the presence of non-linearity in the transmission fiber. Moreover, because of the interplay between dispersion and fiber non-linearity in optical transmission systems, chirp control and dispersion mapping techniques may be employed to achieve improved data transmission performance in high bit rate systems, e.g., about 40 Gbits/s or higher.

It is appreciated that the chirp of modulated optical signals may be controlled by suitably configuring and biasing the respective data modulators 404 and 504. For example, Mach-Zehnder modulators can always give positive chirp if properly biased, and Electro-Absorption (EA) modulators can give positive chirp if properly biased and configured. In addition, directly modulated lasers normally generate positive chirp. It should be further appreciated that the high speed optical transmission systems 400 and 500 employ the data modulators 404 and 504, respectively, to impress both amplitude and phase modulation on the CW light beams provided by the lasers 402 and 502. In alternative embodiments, each of the data modulators 404 and 504 may comprise a respective amplitude modulating unit driven by an electrical NRZ data signal, and a respective phase modulating unit driven by the electrical NRZ data signal or a clock signal related to the NRZ data signal. This alternative embodiment provides increased flexibility in tailoring the strength and time variation of the chirp associated with the modulated optical signals. It is noted that the order of the amplitude and phase modulators is not critical to the performance of the optical transmission systems 400 and 500.

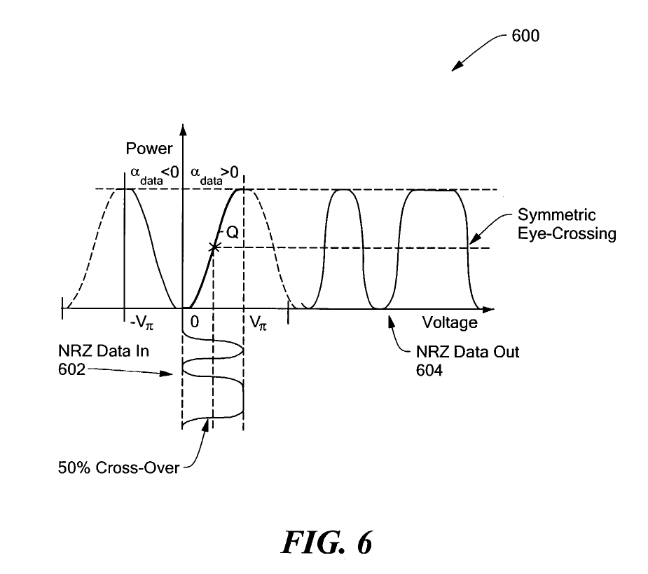

FIG. 6 depicts an illustrative transfer function 600 corresponding to the data modulator 404 (see FIG. 4) or the data modulator 504 (see FIG. 5) configured as a single drive Mach-Zehnder modulator. Like the transfer function 300 (see FIG. 3), the transfer function 600 is periodic and is expressed in terms of the optical power of the modulated signal generated by the data modulator 404 or 504 versus the drive voltage applied to the modulator 404 or 504. As shown in FIG. 6, the alpha parameter is positive (α_{data}>0) in that region of the transfer function 600 where the drive voltage ranges from 0 to V_{π}. It is appreciated that depending on how the Mach-Zehnder modulator is configured and biased, the respective regions of the transfer function 600 corresponding to negative chirp (α_{data}<0) and positive chirp (α_{data}>0) may be opposite what is depicted in FIG. 6. For example, the data modulator 404 or 504 may be configured to generate modulated optical signals such that α_{data}>0 by biasing the modulator at the Q-point in that region of the transfer function 600 where the drive voltage ranges from 0 to V_{π} (see FIG. 6). Accordingly, an electrical NRZ drive signal (Data In) 602 applied to the data modulator 404 or 504 has a 50% cross-over characteristic, and an optical NRZ output signal (Data Out) 604 generated by the modulator has a corresponding symmetric eye-crossing characteristic, as shown in FIG. 6.

It is noted that the data modulator 404 or 504 may comprise a Mach-Zehnder modulator, an EA modulator, or any other suitable type of optical modulator. Further, although the typical transfer function 300 (see FIG. 3) of the single drive Mach-Zehnder modulator is periodic, other types of optical modulators may or may not have periodic transfer functions. In an alternative embodiment, the modulated optical signal may be generated directly by at least one laser such as the lasers 402 and 502 via modulation of the laser current, in which case the external data modulators 404 and 504 may be omitted from the optical transmission systems 400 and 500, respectively. In general, a directly modulated laser generates a modulated optical signal with positive chirp, i.e., α>0. Moreover, fiber non-linearity may be found in Standard Single-Mode Fiber (SSMF), dispersion-managed fiber such as ULTRA-WAVE™ fiber, Non-Zero Dispersion Shifted Fiber (NZDSF) types such as True-Wave-RS™ (TW-RS™) fiber, Large Effective Area Fiber (LEAF™) fiber, and TERA-LIGHT™ fiber, or any other suitable type of optical transmission media. It is noted that NZDSF fiber has dispersion between 2-8 ps/nm/km at 1,550 nm.

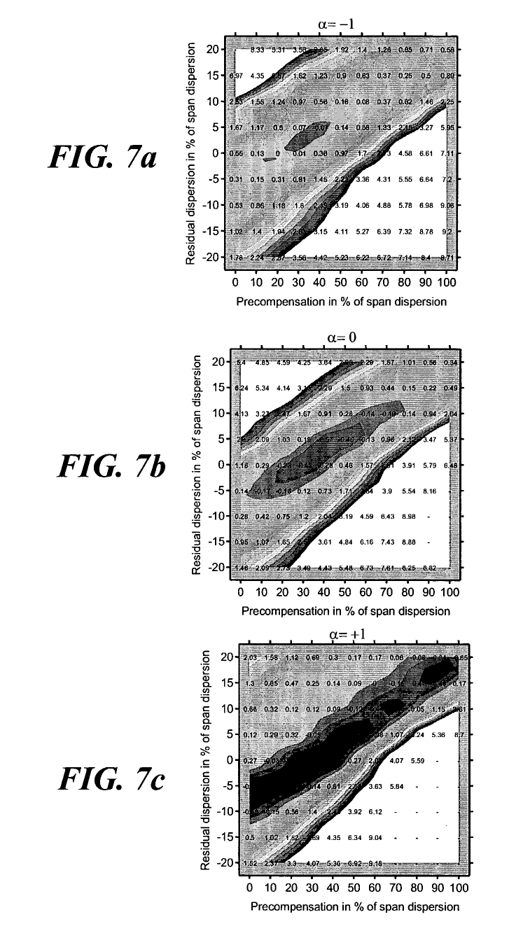

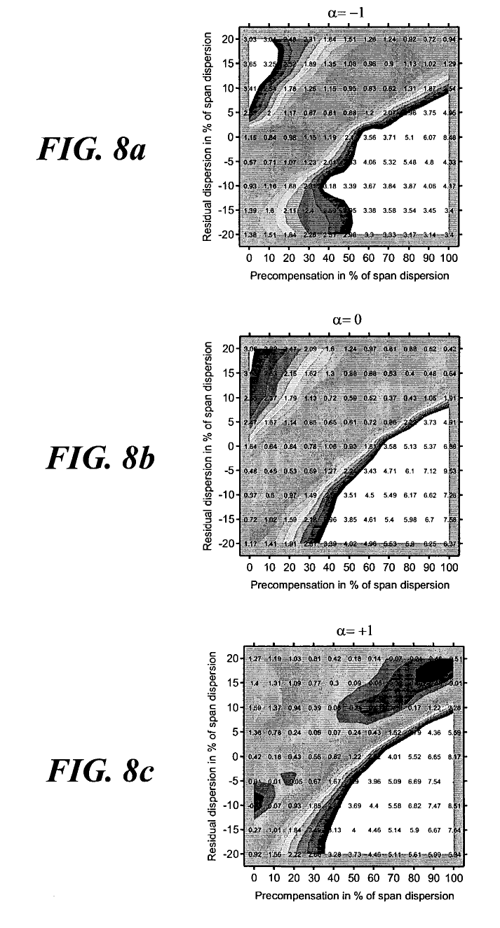

FIGS. 7a-7c and 8a-8c illustrate transmission penalties corresponding to the high speed optical transmission system 400 (see FIG. 4) in a system environment with significant fiber non-linearity and bandwidth limitations. Specifically, FIGS. 7a-7c and 8a-8c illustrate the transmission penalties resulting from transmitting an optical data signal at a bit rate of about 43 Gbits/s through eight spans of 100 km nonlinear TW-RS™ fiber and SSMF fiber, respectively, with negative chirp (α<0), zero chirp (α=0), and positive chirp (α>0). Further, the rise/fall time of the transmitted optical signal is about 13.4 ps, which is indicative of a significant limitation in bandwidth.

It is noted that the transmission penalties of FIGS. 7a-7c and 8a-8c are expressed as a function of the amount of pre-compensation and the residual dispersion per span, i.e., as a function of the dispersion map.

Further, both the pre-compensation and residual dispersion are expressed in terms of the percent of dispersion experienced on a single span of transmission fiber. As indicated by the contour maps of FIGS. 7a-7c and 8a-8c, the transmission penalty is lower for optical signals transmitted with positive chirp (see FIGS. 7c and 8c) than for optical signals transmitted with either negative chirp (see FIGS. 7a and 8a) or zero chirp (see FIGS. 7b and 8b) for both TW-RS™ and SSMF transmission fiber. Transmitting optical signals with positive chirp tends to reduce the transmission penalty because fiber non-linearity typically introduces signal distortion in the form of negative chirp, which is substantially compensated for by the positive chirp of the transmitted signal. Although the transmission penalties illustrated in FIGS. 7a-7c and 8a-8c correspond to single channel data transmission, it is appreciated that similar results are attainable in optical transmission systems with multiple channels, operating at per channel line rates ranging from about 39-50 Gbits/s or higher.

As described above, the optical transmission system 500 (see FIG. 5) can be configured to produce the Data Out signal in the standard RZ data format. In this case, the RZ pulse modulator 506 is operated to carve one RZ pulse in each bit time slot of the data signal driving the data modulator 504. Further, while operating the data modulator 504 such that α_{data}>0, the RZ pulse modulator 506 may be operated such that α_{RZ}<0, α_{RZ}=0, or α_{RZ}>0.

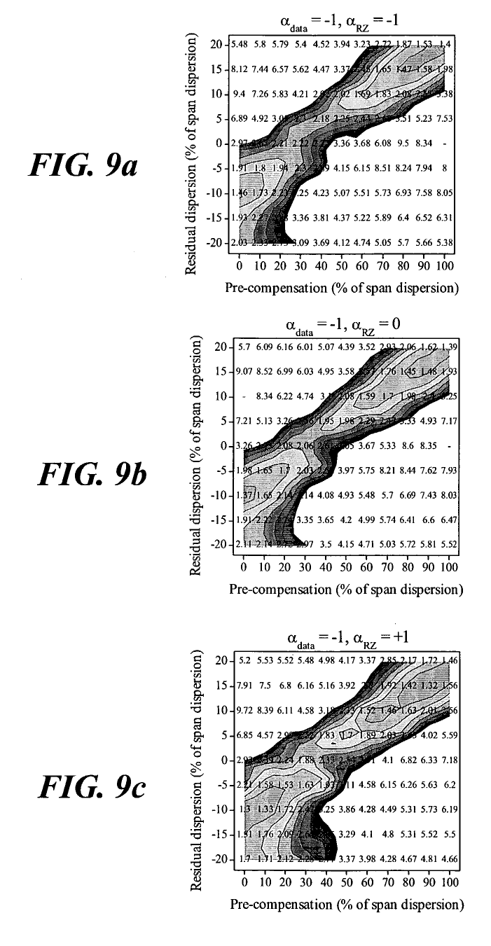

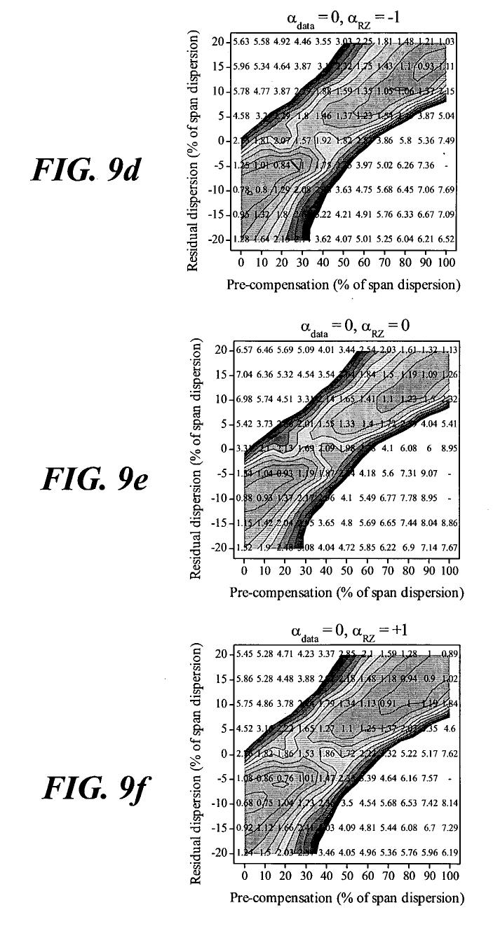

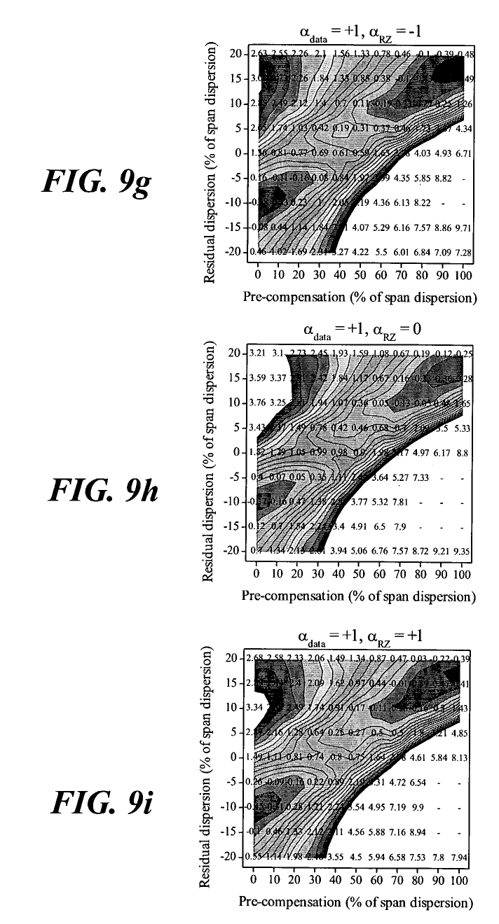

FIGS. 9a-9i illustrate transmission penalties corresponding to the high speed optical transmission system 500 (see FIG. 5) in a system environment with significant fiber non-linearity. Specifically, FIGS. 9a-9i illustrate the transmission penalties resulting from transmitting a standard RZ optical signal at a bit rate of 43 Gbits/s through eight spans of 100 km nonlinear SSMF fiber for different dispersion maps, in which the data modulator 504 and the RZ pulse modulator 506 can impress any combination of negative chirp, zero chirp, and positive chirp on the modulated optical signal. As indicated in FIGS. 9a-9i, the transmission penalty is lower in all cases where the data modulator 504 is operated such that α_{data}>0 (see FIGS. 9g-9i).

In an alternative embodiment, the optical transmission system 500 may be configured to produce a Data Out signal in the carrier-suppressed RZ data format, in which each pair of neighboring optical pulses has a relative phase difference of about π radians. In this case, the RZ pulse modulator 506 may be configured as, e.g., a dual drive Mach-Zehnder modulator operating such that α_{RZ}=0 at a frequency equal to half the bit rate of the data signal. Proper biasing of such a Mach-Zehnder modulator assures that the required phase relationship between neighboring pulses is achieved. Like the transmission penalties for the optical transmission system 500 that produces data output in the standard RZ data format, the transmission penalties corresponding to the system 500 producing data output in the carrier-suppressed RZ format are lower in essentially all cases where the data modulator 504 is operated such that α_{data}>0.

As described above, each of the data modulators 404 and 504 included in the high speed optical transmission systems 400 and 500, respectively, may be biased at quadrature (i.e., at the Q-point, see FIG. 6). In the preferred embodiment, to further enhance the performance of the high speed optical transmission systems 400 and 500, a predetermined bias point for operating the respective data modulators can be offset from quadrature to handle cases in which the peak-to-peak modulator drive voltage is smaller than V_{π} and/or bandwidth limited.

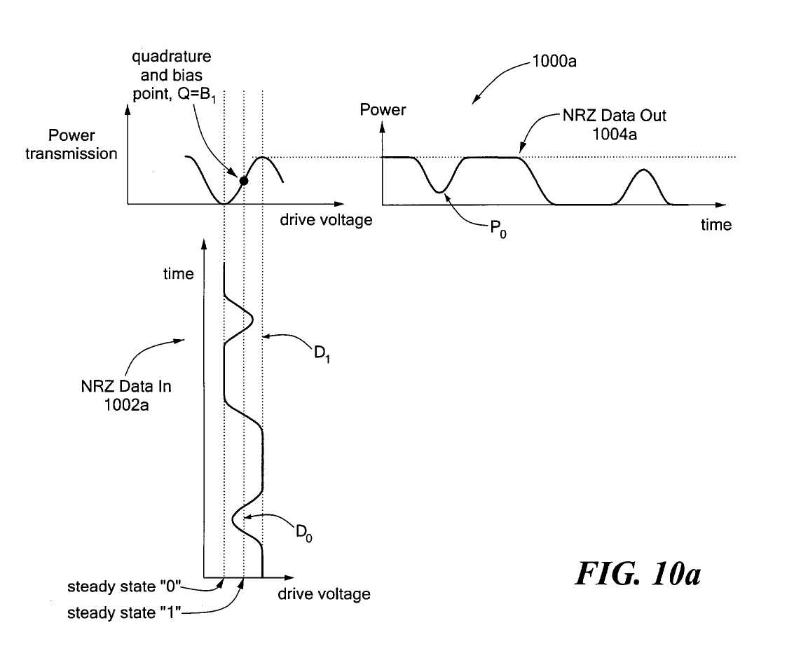

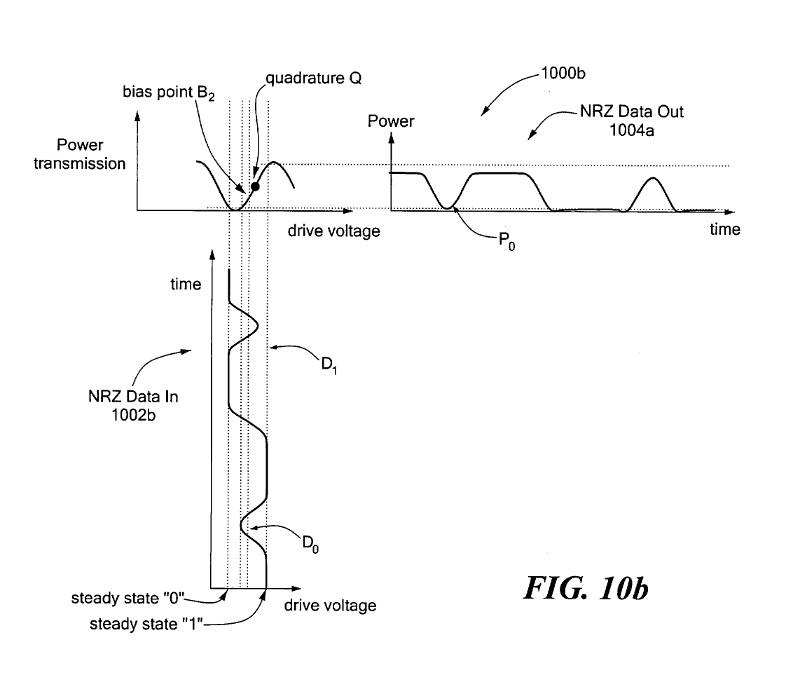

FIG. 10a depicts an illustrative transfer function 1000a corresponding to the data modulator 404 or 504 (see FIGS. 4-5) configured as a single drive Mach-Zehnder modulator. As shown in FIG. 10a, the transfer function 1000a is expressed in terms of the power of the modulated optical signal generated by the modulator versus the drive voltage applied to the modulator. Further, in response to an applied electrical NRZ drive signal (Data In) 1002a, the modulator generates an optical NRZ output signal (Data Out) 1004a. The data modulator 404 or 504 is configured to generate modulated optical signals such that α_{data}>0 at least most of the time by operating the modulator at a predetermined bias point, e.g., a bias point B₁ (see FIG. 10a).

More specifically, FIG. 10a depicts the case in which the modulator is biased at quadrature (i.e., B₁=Q) in the presence of significant bandwidth limitation. With reference to FIG. 10a, “bandwidth limitation” means that the drive voltage for an isolated 0 bit (i.e., D₀) or an isolated 1 bit (i.e., D₁) fails to reach the steady state level (i.e., steady state 0 or steady state 1). It is noted that there can also be internal bandwidth limitation in the modulator. Because of this bandwidth limitation, the power output corresponding to the 0 bit (i.e., P₀) is relatively high, thereby resulting in a poor extinction ratio. The extinction ratio is defined herein as the ratio of the power output associated with a single 1 bit to the power output associated with a single 0 bit.

FIG. 10b depicts another illustrative transfer function 1000b corresponding to the data modulator 404 or 504 (see FIGS. 4-5) configured as a single drive Mach-Zehnder modulator. As shown in FIG. 10b, the transfer function 1000b is expressed in terms of the power of the modulated optical signal generated by the modulator versus the drive voltage applied to the modulator. Further, in response to an applied electrical NRZ drive signal (Data In) 1002b, the modulator generates an optical NRZ output signal (Data Out) 1004b. The data modulator 404 or 504 is configured to generate modulated optical signals such that α_{data}>0 at least most of the time by operating the modulator at a predetermined bias point, e.g., a bias point B₂ (see FIG. 10b).

More specifically, FIG. 10b depicts the case in which the modulator is biased below the quadrature point Q in the presence of significant bandwidth limitation. As explained above, “bandwidth limitation” means that the drive voltage for an isolated 0 bit (i.e., Do) or an isolated 1 bit (i.e., D₁) fails to reach the steady state level (i.e., steady state 0 or steady state 1). Because the bias point B2 is offset from quadrature, the power output corresponding to the 0 bit (i.e., P₀, see FIG. 10b) is lower than that of FIG. 10a, thereby resulting in an improved extinction ratio. In the preferred embodiment, in the presence of bandwidth limitation or too little drive voltage swing, the bias point of the data modulator is moved towards the transmission minimum to improve the extinction ratio.

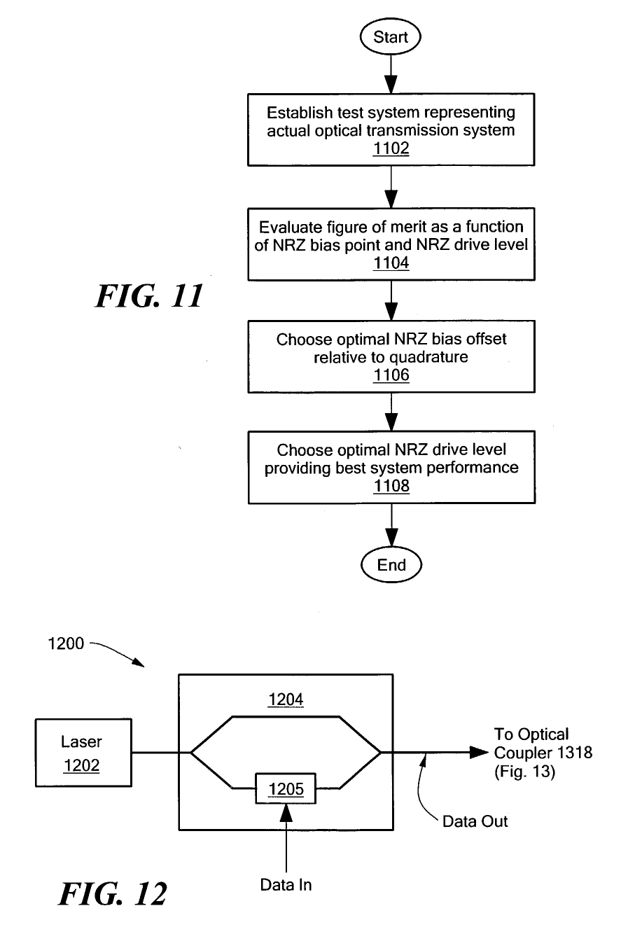

A method of determining the NRZ bias point for operating an external data modulator included in a high speed optical transmission system comprising an optical transmitter, an optical receiver, and transmission fiber coupled between the transmitter and the receiver, is illustrated by reference to FIG. 11. As depicted in step 1102, a test system is established that is representative of the actual optical transmission system 400 or 500. For example, in the event the data modulator 404 or 504 is followed by an optical filter, a similar optical filter is also included in a corresponding data modulator within the test system because the NRZ bias point typically shifts after optical filtering. Next, a figure of merit is evaluated, as depicted in step 1104, as a function of the NRZ bias point and the NRZ drive voltage level. For example, the figure of merit may be the Bit Error Rate (BER) performance, the extinction ratio, the chirp characteristics, or any other suitable figure of merit. The NRZ bias offset relative to quadrature is then chosen, as depicted in step 1106, and the NRZ drive voltage level is chosen, as depicted in step 1108, that provide the best system performance. The preferred embodiment has the optimal figure of merit, which typically corresponds to the case in which the “0” level is fixed. Accordingly, the NRZ bias point is obtained by successively increasing the NRZ bias offset to such an extent that the voltage corresponding to the fixed “0” level is maintained.

It should be appreciated that the choice of the NRZ bias offset and the NRZ drive voltage level for operating the high speed optical transmission systems 400 and 500 may depend upon a number of parameters including (1) the bandwidth, jitter, distortion (e.g., ripple), and variance of the 0 bit and 1 bit levels of the electrical NRZ data signal, (2) the scheme and filtering characteristics of the data modulators 404 and 504, (3) the characteristics of the RZ pulse modulator 506, (4) the bandwidth, spectral shape, and phase characteristics of any optical filters included in the data modulators 404 and 504, (5) the dispersion, non-linearity, and transmission distance of the transmission fiber, and/or (6) the sampling window and bandwidth of the optical receiver.

As described above, the data modulator 404 or the data modulator 504 (see FIGS. 4-5) may be configured as a single drive Mach-Zehnder modulator. FIG. 12 depicts an illustrative embodiment of a high speed digital optical transmission system 1200 including an external data modulator 1204 configured as a single drive Mach-Zehnder modulator, which is operated at a predetermined bias point by closed-loop control of the electrical data signal (“Data In”). It should be noted that the closed-loop control technique described herein may also be employed in conjunction with a push-pull driven dual electrode Mach-Zehnder modulator, or any other suitable type of modulator.

In the illustrated embodiment, a laser 1202 generates a CW light beam, and the Mach-Zehnder modulator 1204 modulates the CW light beam in response to the Data In signal to generate a modulated optical data signal (“Data Out”) having an NRZ modulation format. The Data In signal introduces a phase shift φ(t) in an arm 1205 of the modulator 1204, which is expressed as

φ(t)=θ_{b}+θₘ(t)+δ cos(2πf₀t), (2)

in which “θ_{b}” is a DC bias phase term (in radians), “θₘ(t)” is an AC data modulation phase term (in radians), “δ cos(2πf₀t)” is a sinusoidal electrical dither signal, “δ” is the peak amplitude of the dither signal (in radians), and “f₀” is the frequency of the dither signal.

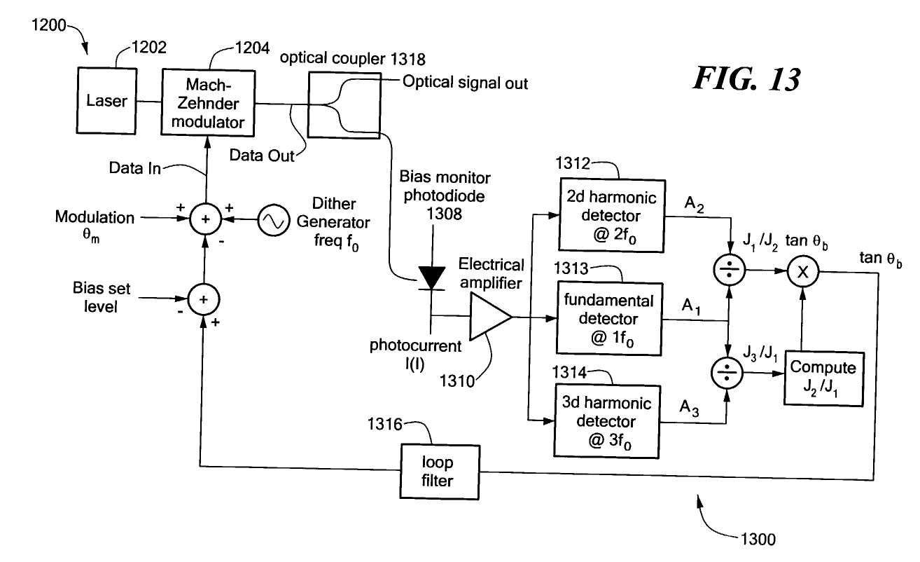

FIG. 13 depicts an illustrative embodiment of a bias offset control loop 1300 employed in conjunction with the Mach-Zehnder modulator 1204 (see also FIG. 12). As indicated in FIG. 13, the dither signal δcos(2πf₀t) is effectively added to the Data In signal applied to the data modulator 1204. Further, a fraction of the Data Out signal generated by the data modulator 1204 is provided to a bias monitor photodiode 1308, which is generally collocated with the modulator 1204. Because of the sinusoidal transfer function of the Mach-Zehnder modulator 1204, the dither signal detected by the bias monitor photodiode 1308 includes fundamental and harmonic frequency terms. The bias offset control loop 1300 may be employed to derive a control observable signal by measuring the amplitudes of the fundamental, second, and third harmonics of the dither signal. This derived control signal may then be used for closed-loop bias control of the Mach-Zehnder modulator 1204.

Specifically, a photo-current I(t) generated by the bias monitor photodiode 1308 is expressed as

I(t)=½RP[1+cos(θ_{b}+θₘ(t)+δ cos(2πf₀t))], (3)

in which “P” is the peak incident optical signal power produced at the maximum transmission point of the modulator 1204, and “R” is the responsivity (in amps per watt) of the photodiode 1308. To analyze the detection of the dither signal and its harmonics, the following series expansions are invoked:

cos(z cos(θ))=J₀(z)+2Σₖ₌₁(−1)^{k}J₂ₖ(z)cos(2kθ) (4)

and

sin(z cos(θ))=2Σₖ₌₀(−1)^{k}J₂ₖ₊₁(z)cos[(2k+1)θ] (5)

in which “Jₙ(x)” is an nth order Bessel function of the first kind. Using equations (4)-(5), the photo-current I(t) can be expanded in terms of the fundamental and harmonic frequencies of the dither signal, i.e.,

$$\begin{matrix}I ( t ) = \frac{1}{2} RP [ 1 + {J}_{0} ( δ ) cos ( {θ}_{b} + {θ}_{m} ( t ) ) - 2 {J}_{1} ( δ ) sin ( {θ}_{b} + {θ}_{m} ( t ) ) cos ( 2 π {f}_{0} t ) \\ - 2 {J}_{2} ( δ ) cos ( {θ}_{b} + {θ}_{m} ( t ) ) cos ( 4 π {f}_{0} t ) + 2 {J}_{3} ( δ ) sin ( {θ}_{b} + {θ}_{m} ( t ) ) cos ( 6 π {f}_{0} t ) + … ]\end{matrix} \qquad ( 6 )$$

It is noted that equation (6) omits additive noise terms such as thermal noise.

As shown in FIG. 13, the photo-current I(t) is provided to an amplifier 1310, which in turn provides an amplified photo-current to fundamental, 2^{nd} harmonic, and 3^{rd} harmonic detection circuitry 1312-1314, which extract the following amplitudes:

A₁=−RPJ₁(δ)<sin(θ_{b}+θₘ(t))> (7)

A₂=−RPJ₂(δ)<cos(θ_{b}+θₘ(t))> (8)

A₃=RPJ₃(δ)<sin(θ_{b}+θₘ(t))>, (9)

in which “< . . . >” denote effects of low-pass filtering in the respective detection circuitry 1312-1314 as an implicit time-average, and the values of “R”, “P”, and “δ” are constant.

In the event that <sin(θₘ(t))>=0 and <cos(θₘ(t))>≠0, equations (7)-(9) can be simplified as

A₁=−RPJ₁(δ)sin(θ_{b})<cos(θₘ(t))> (10)

A₂=−RPJ₂(δ)cos(θ_{b})<cos(θₘ(t))> (11)

A₃=RPJ₃(δ)sin(θ_{b})<cos(θₘ(t))>. (12)

It is noted that the bias information in equations (10)-(12) is contained in the “sin(θ_{b})” and “cos(θ_{b})” terms. Further, to prevent the bias offset control loop 1300 (see FIG. 13) from reacting to temporal variations, the term “<cos(θₘ(t))>” is elminated by forming the ratios

A₁/A₂=[J₁(δ)/J₂(δ)]tan(←_{b}) (13)

A₃/A₁=[−J₃(δ)/J₁(δ)]. (14)

Equation (13) includes the desired control variable “tan(θ_{b})” multiplied by the term “J₁(δ)/J₂(δ)”, which can be treated as gain contributing to the overall loop gain. It is noted that in some instances, it is sufficient to employ just the term “A₁/A₂” as the control variable.

Because the value of the term “J₃(δ)/J₁(δ)” uniquely determines the value of J₂(δ)/J₁(δ) over a predetermined range of values δ, a measurement of “A₃/A₁” can be used to compute “J₂(δ)/J₁(δ)” and subsequently eliminate this term from equation (13). As a result, the desired control observable signal may be expressed as

ρ=(A₁/A₂)(J₂(δ)/J₁(δ)=tan(θ_{b}). (15)

After passing “ρ” through a loop filter 1316, the bias offset can be stabilized to any value of θ_{b} by subtracting a DC bias set level (see FIG. 13) from ρ inside the bias offset control loop 1300, thereby establishing lock where tan(θ_{b}) substantially equals the value of the DC offset.

It is noted that because of the periodicity of the term tan(θ_{b}), there may be multiple stable locking points for a given value of the control observable signal ρ. It is sufficient to distinguish between locking in the interval −π/2<θ_{b}<π/2 and the interval π/2<θ_{b}<3π/2. Because θ_{b}=0 corresponds to the minimum transmission point of the Mach-Zehnder modulator 1204 and θ_{b}=π corresponds to the maximum transmission point of the modulator 1204, the interval of modulator operation can be determined by observing the transmission of the modulator 1204.

It is further noted that in the event the bias offset is to be controlled at the quadrature point θ_{b}=π/2 or odd integer multiples of π/2, the 2^{nd} harmonic vanishes and tan(θ_{b}) becomes unbounded. Accordingly, for operation in the vicinity of θ_{b}=π/2, 3π/2, . . . , the inverted ratio ρ⁻¹ may be employed instead of ρ as the control observable signal, i.e.,

ρ⁻¹=(A₂/A₁)(J₁(δ)/J₂(δ))=cot(θ_{b}), (16)

which leads to

cot(θ_{b}=π/2)=0. (17)

Moreover, at θ_{b} equal to an integer multiple of π, the fundamental and 3^{rd} harmonics vanish, leaving the ratio A₃/A₁ indeterminate except in the limit θ_{b}→nπ for integer n. It is appreciated, however, that the bias control scheme described herein may stabilize the bias offset at a point arbitrarily close to nπ, but not equal to nπ. In an alternative embodiment, the bias offset may be stabilized at θ_{b}=nπ by using the ratio A₁/A₂ as the control observable signal, and not normalizing out the gain factor J₁(δ)/J₂(δ).

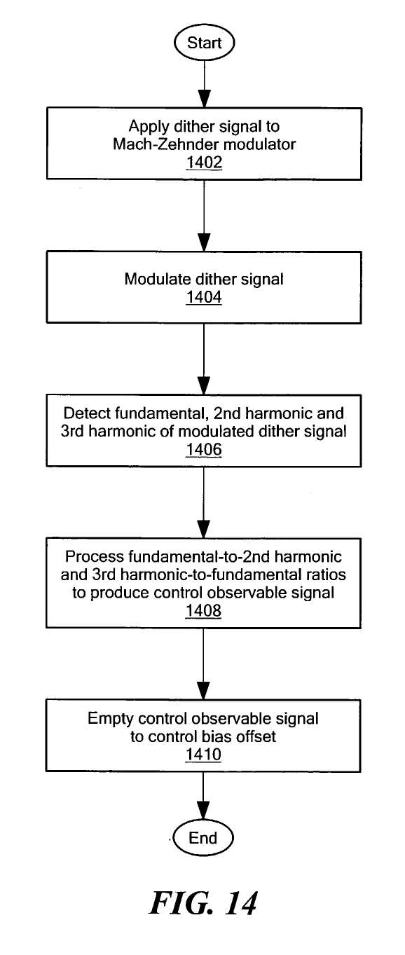

A method of performing closed-loop control of the NRZ bias offset of an external data modulator such as the Mach-Zehnder modulator 1204 included in the high speed optical transmission system 1200 (see FIGS. 12-13) is illustrated by reference to FIG. 14. As depicted in step 1402, a sinusoidal electrical dither signal is applied to the Mach-Zehnder modulator. Next, the dither signal is modulated, as depicted in step 1404, and the electrical fundamental, 2^{nd} harmonic, and 3^{rd} harmonic of the modulated dither signal are detected, as depicted in step 1406. The fundamental-to-2^{nd} harmonic ratio A₁/A₂ and the 3^{rd} harmonic-to-fundamental ratio A₃/A₁ are then processed, as depicted in step 1408, to produce a control observable signal equal to the tangent of the bias angle θ_{b}. In an alternative embodiment, the inverse ratio A₂/A₁ and the 3^{rd} harmonic-to-fundamental ratio A₃/A₁ are processed to produce a control observable signal equal to the cotangent of the bias angle θ_{b}. Finally, the control observable signal is employed, as depicted in step 1410, as a feedback error signal in the bias offset control loop after subtracting a DC bias set level from the control observable signal. It is noted that the operation of the bias offset control loop 1300 (see FIG. 13) is substantially independent of optical power, photo-detector responsivity, dither signal amplitude and frequency, and non-dither data modulation.

It will further be appreciated by those of ordinary skill in the art that modifications to and variations of the above-described chirp control in a high speed optical transmission system may be made without departing from the inventive concepts disclosed herein. Accordingly, the invention should not be viewed as limited except as by the scope and spirit of the appended claims.

What is claimed is:

1. A high speed digital optical transmission system, comprising:
a laser configured to generate a continuous wave (CW) light beam; and
at least one first modulator configured to modulate the CW light beam in response to an electrical non-return-to-zero (NRZ) data signal, thereby generating a modulated NRZ optical signal,
wherein the first modulator is further configured to generate the modulated NRZ optical signal with positive chirp.

2. The system of claim 1 further including at least one second modulator operatively coupled to the first modulator, the second modulator being configured to carve at least one return-to-zero (RZ) pulse from the light beam or the modulated NRZ optical signal.

3. The system of claim 2 wherein the second modulator is configured to generate a modulated carrier-suppressed RZ optical signal.

4. The system of claim 3 wherein the first modulator is biased so that the chirp of the modulated NRZ optical signal is positive for 100% of each bit time slot.

5. The system of claim 3 wherein the first modulator is biased so that the chirp of the modulated NRZ optical signal is positive for at least 80% of each bit time slot.

6. The system of claim 5 further including a transmission medium configured to carry the modulated carrier-suppressed RZ optical signal, the transmission medium comprising positive dispersion optical fiber.

7. The system of claim 3 wherein the first modulator is biased so that the chirp of the modulated NRZ optical signal is positive for at least 80% of each bit time slot and negative for up to 20% of each bit time slot.

8. The system of claim 2 further including a transmission medium configured to carry the modulated RZ optical signal, the transmission medium comprising positive dispersion optical fiber.

9. The system of claim 1 further including a transmission medium configured to carry the modulated NRZ optical signal.

10. The system of claim 9 wherein the transmission medium comprises negative dispersion optical fiber.

11. The system of claim 9 wherein the transmission medium is selected from the group consisting of True-Wave-RS™ fiber, Large Effective Area Fiber fiber, dispersion-managed fiber, Standard Single-Mode Fiber, and NZDSF fiber.

12. The system of claim 1 wherein the first modulator is further configured to generate the modulated optical signal at a per channel line rate ranging from about 39-50 Gbits/s.

13. The system of claim 1 wherein the first modulator has an associated transfer function, the first modulator being biased at a predetermined bias point of the transfer function.

14. The system of claim 13 wherein the predetermined bias point is offset from a quadrature point of the transfer function such that a duty cycle of the modulated NRZ optical signal is reduced.

15. The system of claim 1 wherein the first modulator is biased so that the chirp of the modulated NRZ optical signal is positive for 100% of each bit time slot.

16. The system of claim 1 wherein the first modulator is biased so that the chirp of the modulated NRZ optical signal is positive for at least 80% of each bit time slot.

17. The system of claim 1 wherein the first modulator is biased so that the chirp of the modulated NRZ optical signal is positive for at least 80% of each bit time slot and negative for up to 20% of each bit time slot.

18. The system of claim 1 wherein the first modulator comprises first and second modulator units, the first unit being configured to impress amplitude modulation and the second unit being configured to impress phase modulation, so that an output of the first modulator is a signal with NRZ intensity modulation and predominantly positive chirp.

19. The system of claim 1 wherein the first modulator is selected from the group consisting of a Mach-Zehnder modulator and an electro-absorption modulator.

20. A method of operating a high speed digital optical transmission system, comprising the steps of:
generating a continuous wave (CW) light beam by a laser; and
modulating the CW light beam in response to an electrical non-return-to-zero (NRZ) data signal to generate a modulated NRZ optical signal with positive chirp by at least one first modulator.

21. The method of claim 20 further including the step of carving at least one return-to-zero (RZ) pulse from the light beam or the modulated NRZ optical signal by a second modulator.

22. The method of claim 21 wherein the carving step includes carving the RZ pulse from the modulated NRZ optical signal to generate a modulated carrier-suppressed RZ optical signal by the second modulator.

23. The method of claim 21 further including the step of transmitting the modulated RZ optical signal over a transmission medium, the transmission medium comprising positive dispersion optical fiber.

24. The method of claim 20 further including the step of transmitting the modulated NRZ optical signal over a transmission medium, the transmission medium being selected from the group consisting of negative dispersion optical fiber, positive dispersion optical fiber, True-Wave-RS™ fiber, Large Effective Area Fiber fiber, dispersion-managed fiber, Standard Single-Mode Fiber, and NZDSF fiber.

25. The method of claim 20 further including the step of transmitting the modulated optical signal at a per channel line rate ranging from about 39-50 Gbits/s.

26. A high speed digital optical transmission system, comprising:
a laser configured to generate a continuous wave (CW) light beam; and
a data modulator configured for modulating the CW light beam in response to an electrical non-return-to-zero (NRZ) data signal to generate a modulated NRZ optical signal, the data modulator having an associated transfer function and being biased at a predetermined bias point of the transfer function,
wherein the predetermined bias point is offset from a quadrature point of the transfer function.

27. The system of claim 26 wherein the predetermined bias point is offset from the quadrature point of the transfer function such that a duty cycle of the modulated NRZ optical signal is reduced.

28. The system of claim 26 wherein the data modulator is biased to operate so that the chirp of the modulated NRZ optical signal is positive for 100% of each bit time slot.

29. The system of claim 26 wherein the data modulator is biased to operate so that the chirp of the modulated NRZ optical signal is positive for at least 80% of each bit time slot.

30. The system of claim 29 wherein the data modulator is biased to operate so that the chirp of the modulated NRZ optical signal is positive for at least 80% of each bit time slot, and to operate so that the chirp of the modulated NRZ optical signal is negative for up to 20% of each bit time slot.

31. The system of claim 26 wherein the system is configured to operate at a bit rate ranging from about 39-50 Gbits/s.

32. A method of operating a high speed digital optical transmission system, comprising the steps of:
generating a continuous wave (CW) light beam by a laser; and
modulating the CW light beam in response to an electrical non-return-to-zero (NRZ) data signal to generate a modulated NRZ optical signal by a data modulator, the data modulator having an associated transfer function and being biased at a predetermined bias point of the transfer function, the predetermined bias point being offset from a quadrature point of the transfer function.

33. The method of claim 32 wherein the modulating step includes modulating the CW light beam in response to the electrical NRZ data signal to generate the modulated NRZ optical signal by the data modulator, the predetermined bias point being offset from the quadrature point of the transfer function such that a duty cycle of the modulated NRZ optical signal is reduced.

34. The method of claim 32 wherein the modulating step includes modulating the CW light beam in response to the electrical NRZ data signal to generate the modulated NRZ optical signal by the data modulator, the data modulator being biased to operate so that the chirp of the modulated NRZ optical signal is positive for 100% of each bit time slot.

35. The method of claim 32 wherein the modulating step includes modulating the CW light beam in response to the electrical NRZ data signal to generate the modulated NRZ optical signal by the data modulator, the data modulator being biased to operate so that the chirp of the modulated NRZ optical signal is positive for at least 80% of each bit time slot.

36. The method of claim 35 wherein the modulating step includes modulating the CW light beam in response to the electrical NRZ data signal to generate the modulated NRZ optical signal by the data modulator, the data modulator being biased to operate so that the chirp of the modulated NRZ optical signal is negative for up to 20% of each bit time slot.

37. The method of claim 32 further including the step of operating the system at a bit rate ranging from about 39-50 Gbits/s.

38. A high speed digital optical transmission system, comprising:
at least one laser configured to generate a modulated light beam in response to an electrical non-return-to-zero (NRZ) data signal, thereby generating a modulated NRZ optical signal,
wherein the laser is further configured to generate the modulated NRZ optical signal with positive chirp.

39. The system of claim 38 further including a pulse modulator configured to carve at least one return-to-zero (RZ) pulse from the modulated NRZ optical signal, thereby generating a modulated RZ optical signal.

40. The system of claim 39 wherein the pulse modulator is configured to generate a modulated carrier-suppressed RZ optical signal.

41. The system of claim 39 further including a transmission medium configured to carry the modulated RZ optical signal, the transmission medium comprising positive dispersion optical fiber.

42. The system of claim 38 further including a transmission medium configured to carry the modulated NRZ optical signal.

43. The system of claim 42 wherein the transmission medium comprises negative dispersion optical fiber.

44. The system of claim 42 wherein the transmission medium is selected from the group consisting of negative dispersion fiber, positive dispersion fiber, TW-RS fiber, LEAF fiber, TERA-LIGHT fiber, ULTRA-WAVE fiber, dispersion-managed fiber, SSMF fiber, and NZDSF fiber.

45. The system of claim 38 wherein the laser is further configured to generate the modulated optical signal at a per channel line rate ranging from about 39-50 Gbits/s.

46. The system of claim 38 wherein the laser is further configured to generate the modulated NRZ optical signal with positive chirp for at least 80% of each bit time slot.

47. The system of claim 38 wherein the laser is further configured to generate the modulated NRZ optical signal with positive chirp for at least 80% of each bit time slot and negative chirp for up to 20% of each bit time slot.

48. A method of operating a high speed digital optical transmission system, comprising the steps of:
generating a modulated non-return-to-zero (NRZ) optical signal with positive chirp in response to an electrical NRZ data signal by at least one laser; and
transmitting the modulated NRZ optical signal over a data transmission channel at a predetermined bit rate.

49. The method of claim 48 further including the step of carving at least one return-to-zero (RZ) pulse from the modulated NRZ optical signal to generate a modulated RZ optical signal by a pulse modulator.

50. The method of claim 49 wherein the carving step includes carving the RZ pulse from the modulated NRZ optical signal to generate a modulated carrier-suppressed RZ optical signal by the pulse modulator.

51. The method of claim 49 wherein the transmitting step includes transmitting the modulated RZ optical signal over a transmission medium, the transmission medium being selected from the group consisting of negative dispersion fiber, positive dispersion fiber, TW-RS fiber, LEAF fiber, TERA-LIGHT fiber, ULTRA-WAVE fiber, dispersion-managed fiber, SSMF fiber, and NZDSF fiber.

52. The method of claim 48 wherein the transmitting step includes transmitting the modulated NRZ optical signal over a transmission medium, the transmission medium being selected from the group consisting of negative dispersion fiber, positive dispersion fiber, TW-RS fiber, LEAF fiber, TERA-LIGHT fiber, ULTRA-WAVE fiber, dispersion-managed fiber, SSMF fiber, and NZDSF fiber.

53. The method of claim 48 wherein the transmitting step includes transmitting the modulated optical signal over the data transmission channel at a per channel line rate ranging from about 39-50 Gbits/s by the laser.

54. A method of determining a bias point for operating a non-return-to-zero (NRZ) data modulator included in a high speed digital optical transmission system, the NRZ data modulator being configured to modulate a continuous wave (CW) light beam in response to an electrical NRZ data signal to generate a modulated NRZ optical signal, the method comprising the steps of:
successively increasing a bias offset voltage relative to a quadrature point of a transfer function associated with the NRZ data modulator;
evaluating a figure of merit of the NRZ data modulator as a function of each successive increase of the bias offset relative to quadrature; and
choosing the bias point corresponding to the bias offset that yields a figure of merit value indicative of improved system performance.

55. The method of claim 54 wherein the evaluating step includes evaluating the figure of merit as a function of the bias voltage and a drive voltage of the electrical NRZ data signal.

56. The method of claim 55 further including the step of choosing the bias voltage and the drive voltage that yields a figure of merit value indicative of improved system performance.

57. The method of claim 55 wherein the increasing step includes successively increasing the bias voltage relative to quadrature to maintain the drive voltage of a logical low level at a predetermined value.

58. The method of claim 54 wherein the evaluating step includes evaluating the figure of merit of the NRZ data modulator, the figure of merit being selected from the group consisting of a bit error rate, an extinction ratio, and a chirp characteristic.

59. The method of claim 54 further including the step of operating the system at a bit rate ranging from about 39-50 Gbits/s.

60. A method of performing closed-loop control of a bias offset of a non-return-to-zero (NRZ) data modulator included in a high speed digital optical transmission system, comprising the steps of:
applying an electrical data signal, an electrical dither signal, and an optical signal to the NRZ data modulator;
modulating the optical signal with a sum of the data signal and the dither signal by the NRZ data modulator;
monitoring an optical output of the NRZ data modulator by a photodiode;
determining a fundamental harmonic, a second harmonic, and a third harmonic of a dither frequency component in a photo current of the photodiode;
processing a fundamental harmonic-to-second harmonic ratio and a third harmonic-to-fundamental harmonic ratio to produce a control observable signal; and
employing the control observable signal as a feedback error signal to control the bias offset of the NRZ data modulator.

61. The method of claim 60 further including subtracting a DC bias set level from the control observable signal.

62. The method of claim 60 wherein the applying step includes applying the data signal, the dither signal, and the optical signal to the NRZ data modulator, the NRZ data modulator comprising a Mach-Zehnder modulator.

63. The method of claim 60 wherein the processing step includes processing the fundamental harmonic-to-second harmonic ratio and the third harmonic-to-fundamental harmonic ratio to produce the control observable signal, the control observable signal being equal to the tangent of a bias angle.

64. The method of claim 60 wherein the processing step includes processing the fundamental harmonic-to-second harmonic ratio and the third harmonic-to-fundamental harmonic ratio to produce the control observable signal, the control observable signal being equal to the cotangent of a bias angle.

65. The method of claim 60 further including the step of operating the system at a bit rate ranging from about 39-50 Gbits/s.
